(19) United States
(12) Patent Application Publication
(10) Pub. No.: US 2026/0141279 A1
(43) Pub. Date: May 21, 2026

(54) DOUBLE ENDED MEASUREMENTS

(71) Applicant: Google LLC, Mountain View, CA (US)

(72) Inventors: Matthew James McEwen, Santa Barbara, CA (US); Craig Gidney, Goleta, CA (US)

(21) Appl. No.: 18/938,990

(22) Filed: Nov. 6, 2024

(51) Int. Cl. G06N 10/40; G06N 10/70

(52) U.S. Cl. CPC G06N 10/40; G06N 10/70

(57) ABSTRACT

Methods, systems and apparatus for double-ended measurement of a qubit. In one aspect, a digital representation of a readout signal that characterizes an interaction between a qubit and a readout resonator during a readout operation is obtained. The digital representation of the readout signal is processed using a first set of integration weights to obtain a first value that represents a measured result of the readout operation. The digital representation of the readout signal is also processed using a second set of integration weights to obtain a second value that represents a quantum state of the qubit after the readout operation, where the second set of integration weights is different to the first set of integration weights.

### BACKGROUND

This specification relates to quantum computing.

Classical computers have memories made up of bits, where each bit can represent either a zero or a one. Quantum computers maintain sequences of quantum bits, called qubits, where each quantum bit can represent a zero, one or any quantum superposition of zeros and ones. Quantum computers operate by setting qubits in an initial state and manipulating the state of the qubits, e.g., according to a sequence of quantum logic gates. A calculation ends with qubit state readout, collapsing the state of the system of qubits into an eigenstate where each qubit represents either a zero or one.

### SUMMARY

This specification describes technologies for double-ended measurements of qubits in a quantum computing device.

In general, one innovative aspect of the subject matter described in this specification can be implemented in a method that includes obtaining a digital representation of a readout signal that characterizes an interaction between a qubit and a readout resonator during a readout operation; and processing the digital representation of the readout signal, comprising:
processing the digital representation of the readout signal using a first set of integration weights to obtain a first value that represents a measured result of the readout operation; and processing the digital representation of the readout signal using a second set of integration weights to obtain a second value that represents a quantum state of the qubit after the readout operation, wherein the second set of integration weights is different to the first set of integration weights.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations processing the digital representation of the readout signal using the first set of integration weights comprises integrating the digital representation of the readout signal using the first set of integration weights over a first integration window; and processing the digital representation of the readout signal using the second set of integration weights comprises integrating the digital representation of the readout signal using the second set of integration weights over a second integration window, wherein the first integration window and the second integration window are disjoint.

In some implementations the first integration window precedes the second integration window.

In some implementations the readout operation is equivalent to a measurement operation on the qubit followed by a state preparation operation on the qubit.

In some implementations the first set of integration weights and second set of integration weights are predetermined based on an energy decay rate of the readout resonator and target fidelities of the first value and the second value.

In some implementations the first set of integration weights and second set of integration weights are predetermined based on an information flow density of the readout signal.

In some implementations processing the digital representation of the readout signal using the first set of integration weights comprises integrating the digital representation of the readout signal using the first set of integration weights over a first integration window; and processing the digital representation of the readout signal using the second set of integration weights comprises integrating the digital representation of the readout signal using the second set of integration weights over a second integration window, wherein the first integration window and the second integration window overlap.

In some implementations the readout operation comprises a long readout operation with a readout duration of one or more microseconds.

In some implementations the first set of integration weights and second set of integration weights are predetermined based on an information flow density of the readout signal, a decay rate of the readout resonator, a decay rate of the qubit, and target fidelities of the first value and the second value.

In some implementations the first set of integration weights follow a decay rate of the readout resonator in a first period of the first integration window and follow a decay rate of the qubit in a second period of the first integration window, wherein the first period precedes the second period.

In some implementations the second set of integration weights comprise a time reverse of the first set of integration weights.

In some implementations the overlap is less than a predetermined threshold, wherein the predetermined threshold depends on a predicted likelihood that a correlated error between the first value and the second value occurs during the readout operation.

In some implementations the predicted likelihood that the correlated error occurs is equal to p², wherein p represents a predicted likelihood that the first value is erroneous and represents a likelihood that the second value is erroneous.

In some implementations the readout operation is equivalent to a measurement operation on the qubit followed by a state preparation operation on the qubit.

In some implementations the qubit comprises a measure qubit and the readout operation is performed as part of a syndrome measurement in a quantum error correction cycle that is performed during a quantum computation.

In some implementations the method further comprises providing the first value and the second value to a quantum error correction decoder to detect errors in the quantum computation.

In some implementations the quantum error correction decoder generates a decoder graph using the first value and the second value, wherein a decoding algorithm is performed on the decoder graph to detect the errors in the quantum computation.

In some implementations the method further comprises performing, by quantum computing hardware, the readout operation on the qubit and the readout resonator.

In some implementations the qubit is a superconducting qubit, the readout resonator is a microwave cavity, and the readout signal is a microwave signal.

In general, another innovative aspect of the subject matter described in this specification can be implemented in a method performed by a quantum computing device, the method comprising: during execution of a quantum computation that uses a quantum error correction code: for each detector in the quantum error correction code: for each measure qubit associated with the detector: processing a digital representation of a readout signal for the measure qubit for the detector using a first set of integration weights to obtain a first value that represents a measured readout result; and processing the digital representation of the readout signal using a second set of integration weights to obtain a second value that represents a quantum state of the measure qubit for the detector after readout, wherein the second set of integration weights is different to the first set of integration weights; and summing, over each measure qubit associated with the detector, the first value and second value to obtain a value for the detector; generating a detector graph using the values for each detector in the quantum error correction code; and executing a decoding algorithm on the detector graph to compute a decoding output that predicts an occurrence of errors in the quantum computation.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The subject matter described in this specification can be implemented in particular ways so as to realize one or more of the following advantages.

The presently described double-ended measurement provides two independent bits of information—a measurement value and a prepare value—with one physical operation. The physical operation does not require additional or new hardware and can be implemented using current measurement techniques. In addition, the double-ended measurement is designed such that correlated errors between the measurement value and the prepare value can be suppressed to a target threshold.

In a quantum error correction setting, the presently described double-ended measurement enables quantum error correction circuits to be implemented without reset operations and maintaining a same level of error suppression, avoiding the increased hardware complexity associated with reset operations. Further, the reset operations (or any state preparation operations) are avoided without requiring additional quantum error correction cycles to be run.

Details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that compares a standard quantum circuit for measurement and preparation to a quantum circuit for the presently described double-ended measurement operation.

FIG. 2A depicts an example system for double-ended measurement of a qubit.

FIG. 2B depicts the example system of FIG. 2A during execution of a quantum error correction code.

FIG. 3 shows three plots of example sets of integration weights for processing a digital representation of a readout signal.

FIG. 4 is a flow diagram of an example process for double-ended measurement of a qubit in a quantum computing device.

FIG. 5 is a flow diagram of an example process for double-ended measurement of a qubit in a quantum computing device that implements a quantum error correction code.

FIG. 6 depicts an example quantum computing device.

Like reference numbers and designations in the various drawings indicate like elements.

### DETAILED DESCRIPTION

This specification describes a double-ended measurement operation that provides two independent bits of information instead of one—a measurement value and a state preparation value. In the context of quantum error correction, in implementations where the measurement value and state preparation value are independent or satisfy a correlation constraint, the double-ended measurement operation removes the time-like errors that halve the time-like distance, avoiding the need to run the quantum error correction cycle twice as many times to achieve a same error suppression during logical operations.

Quantum circuits typically include measurement operations that are applied to respective qubits to obtain information about the quantum states of the qubits at the time of the measurement. Whilst the quantum state of a qubit is known after a measurement operation, many quantum circuits perform a reset operation after the measurement operation to prepare the qubit in a specific state, e.g., the +Z eigenstate. Since the measurement operation and reset operation are separate operations, their errors are uncorrelated. This means that if the measurement operation failed and produced an erroneous result, the error would only affect the measurement result and not the reset (which, in turn, would affect subsequent computations performed by the qubit). This is particularly important in quantum error correction circuits, where error mechanisms can travel through the quantum circuit if detector regions overlap.

More generally, in many applications (including quantum error correction) a state preparation operation can be performed after the measurement operation instead of a reset operation. This is because it is often the case that the exact eigenstate that the qubit is prepared in after measurement is not important (and does not even have to be reliable), as long as the eigenstate is known. A state preparation operation is a non-deterministic reset operation that either performs a reset operation, e.g., to prepare the qubit in the +Z eigenstate, or performs an anti-reset operation, e.g., to prepare the qubit in the −Z eigenstate, where the state preparation operation outputs a value that specifies which quantum state has been prepared. The state preparation operation can therefore be viewed as a reverse measurement operation since the state preparation operation provides information about the quantum state of the qubit after the measurement operation rather than before/at the time of the measurement operation.

However, reset operations (and anti-reset operations, which can be implemented as a reset operation followed by a Pauli X gate) are typically difficult or costly to implement in quantum computing hardware. For example, the quantum computing hardware would have to be designed such that the qubit can directly interact with the readout circuit (to perform the reset operation) as well as indirectly interact with the readout circuit (to perform a readout operation). Designing the quantum computing hardware to enable this is difficult and adds an additional layer of complexity. As another example, the quantum computing hardware would have to include two separate readout circuits, one for performing the reset operation and another to perform the readout operation, increasing the amount of hardware on the chip.

Some quantum circuits can be implemented without reset operations to avoid the above described increased hardware complexity. However, omitting reset operations typically reduces error suppression or increases the computational runtime if the same error suppression is to be achieved. For example, quantum error correction circuits without reset operations (or more generally, without a state preparation operation) are possible, but typically suffer from a 2× reduction in the time-like distance, which in turn requires the quantum error correction cycle to be run twice as many times for the same error suppression during logical operations.

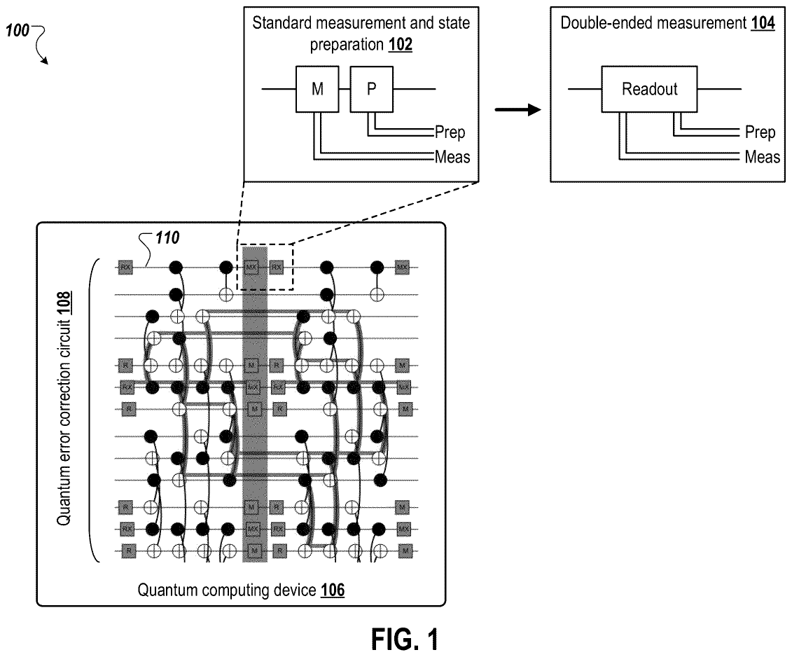

FIG. 1 is a diagram 100 that compares a standard quantum circuit for measurement and state preparation 102 to a quantum circuit for the presently described double-ended measurement operation 104. As discussed above, a quantum computing device 106 implements a quantum circuit, e.g., a quantum error correction circuit 108. The quantum circuit includes one or more instances where a qubit is measured and then prepared in some quantum state. For example, in the quantum error correction circuit 108, each measure qubit, e.g., measure qubit 110, is measured and reset (which is an example of a state preparation operation) after each round of error detection.

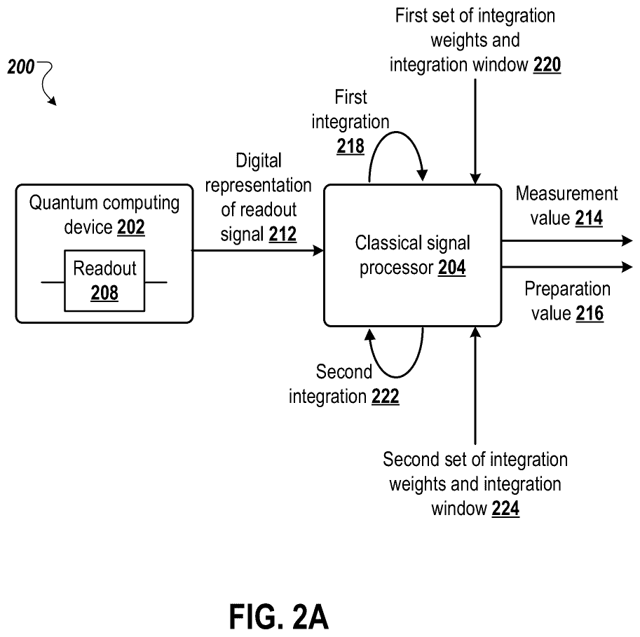

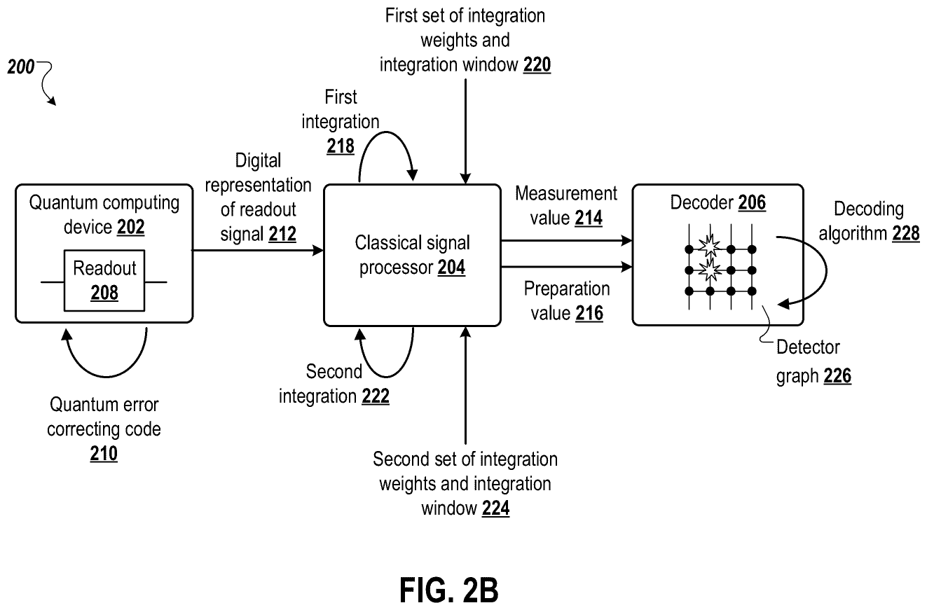

In the standard measurement and state preparation quantum circuit 102, a measurement operation “M” and a state preparation operation “P” are applied to the qubit. The measurement operation “M” produces a first classical bit “meas” that specifies the quantum state of the qubit at the time of the measurement. The state preparation operation “P” produces a second classical bit “prep” that specifies the quantum state of the qubit after the measurement operation. These two classical bits are processed as part of the computation being performed by the quantum computing device 106. For example, in the case of quantum error correction, the two classical bits can be provided to a classical decoder that is configured to detect the presence of errors in the computation, as described in more detail below with reference to FIG. 2B.

In the presently described double-ended measurement quantum circuit 104, the measurement operation “M” and state preparation operation “P” in the standard measurement and state preparation quantum circuit 102 are replaced with a single readout operation “Readout.” The single readout operation “Readout” requires the same hardware used for the measurement operation “M,” but alleviates the need for a subsequent reset or state preparation operation “P” since the single readout operation returns both classical bits “meas” and “prep” whilst preserving independent of failure, as described in more detail below with reference to FIGS. 2A-B, 3-5.

FIG. 2A depicts an example system 200 for double-ended measurement of a qubit. The example system 200 is an example of a system implemented as part of a quantum computing device in which the systems, components and techniques described in this specification can be implemented. The system 200 includes a quantum computing device 202 and a classical signal processor 204. In some implementations, the components of the example system 200 can be directly connected. In other implementations, the components of the example system 200 can be connected through a network, e.g., a local area network (LAN), wide area network (WAN), the Internet, or a combination thereof.

The quantum computing device 202 includes components for performing quantum computations. For example, the quantum computing device 102 can include a quantum data plane that, in turn, includes multiple physical qubits, a control and measurement plane configured to perform operations and measurements on the physical qubits, a control processor plane that is configured to determine sequences of operations and measurements that a quantum algorithm being performed by the quantum computing system requires, and a classical computer that is in data communication with the control processor and facilitates user interactions and access to networks or storage.

The quantum computations performed by the quantum computing device 202 involve performing measurements on one or more physical qubits to extract classical results of the computations. The measurements can occur at the end of a computation or during the computation, e.g., in quantum error correction settings. To measure a physical qubit, the quantum computing device 202 is configured to perform a readout operation 208. The readout operation 208 probes the quantum state of the qubit and generates a readout signal which can be digitalized and provided to the classical signal processor 204. The classical signal processor 204 then analyzes the digitalized readout signal to determine a result of the readout operation 208, as described in more detail below.

For example, in some implementations the physical qubits included in the quantum computing device 202 can be superconducting qubits, e.g., transmon qubits, flux qubits, phase qubits, or other qubits that use microwave signals for readout, e.g., hybrid qubits such as NV centers coupled to microwave resonators. In these implementations, to measure the physical qubits, the control and measurement plane can include readout resonators, e.g., microwave resonators, that are coupled to the physical qubits. Typically, each readout resonator is designed such that its resonant frequency shifts depending on the quantum state of the qubit to which it is coupled to, e.g., due to the interaction between the qubit and the resonator. To perform a readout, the control electronics can generate a control pulse, e.g., microwave pulse, that is applied to the readout resonator at a drive frequency that is close to the readout resonator resonance frequency. In some implementations the control pulse can be a square pulse.

The readout resonator responds differently depending on whether the qubit to which it is coupled to is in a 0 or 1 state. Therefore, after the control pulse has been applied to the readout resonator, the resulting readout signal (reflected back from the readout resonator or transmitted through the readout resonator) can be measured to infer the quantum state of the qubit. In some implementations the control and measurement plane can also include readout amplifiers that boost weak readout signals output from the readout resonators to increase the accuracy of the measurement. The control and measurement plane can also include an analog-to-digital converter that is configured to convert analog signals, e.g., a voltage from a (amplified) readout signal produced by the readout resonator, into a digital representation of the readout signal 212 that can be processed by the classical signal processor 204.

The classical signal processor 204 is a processor that can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, one or more qubits, or a combination of one or more of them.

The classical signal processor 204 is configured to receive digitalized readout signals from the quantum computing device 202, e.g., a digitalized representation of a readout signal 212 that characterizes an interaction between a qubit and a readout resonator during a readout operation 208 performed by the quantum computing device 202. The classical signal processor 204 is configured to perform signal processing techniques to analyze the digitalized representation of the readout signal 212 and obtain information about the quantum state of the qubit.

In particular, the classical signal processor 204 is configured to process the digitalized representation of the readout signal 212 to obtain two values—a measurement value 214 that represents a result of the readout operation (the quantum state of the qubit at the time of the measurement) and a preparation value 216 that represents the quantum state of the qubit after the measurement operation.

To obtain the measurement value 214, the classical signal processor 204 performs a first integration 218 of the digitalized representation of the readout signal 212 using a first set of integration weights and a first integration window 220. To obtain the preparation value 216, the classical signal processor 204 performs a second integration 222 of the digitalized representation of the readout signal 212 using a second set of integration weights and a second integration window 224. Each integration window defines a time range over which the digitalized representation of the readout signal 212 is integrated. The sets of integration weights are coefficients that are applied to different parts of the digitalized representation of the readout signal 212 during the integration, e.g., such that parts of the signal that carry more information about the quantum state of the qubit are enhanced.

In some implementations the first integration window and the second integration window are disjoint (and therefore the first set of integration weights and the second set of integration weights are disjoint). In these implementations, the integration curves defined by the first set of integration weights and the second set of integration weights are disjoint, therefore the first integration 218 and the second integration 222 are disjoint. This means that the predicted correlated error between the outputs of the integrations—the measurement value 214 and the preparation value 216—is zero.

In other implementations the first integration window and the second integration window can overlap, e.g., the first integration window and the second integration window can be a same integration window. In these implementations, the integration curves defined by the first set of integration weights and the second set of integration weights can overlap (that is, the first integration 218 and the second integration 222 overlap). This means that the predicted correlated error between the outputs of the integrations—the measurement value 214 and the preparation value 216—is non-zero. To sufficiently suppress the predicted correlated error, the overlap between the integrations can be bounded by p², where p represents both a predicted likelihood that the measurement value 214 is erroneous and predicted a likelihood that the preparation value 216 is erroneous. This is because there are two natural error mechanisms already in the circuit (an error mechanism for the measurement operation and an error mechanism for the state preparation) that can combine to cause the same problem that this overlap causes. Each of these two error mechanisms occur with probability p. The probability of both occurring together is p².

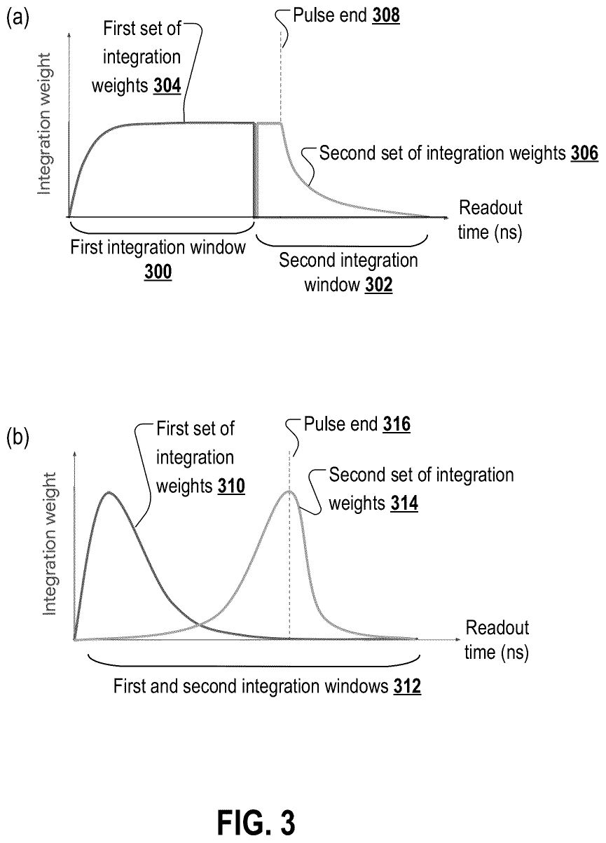

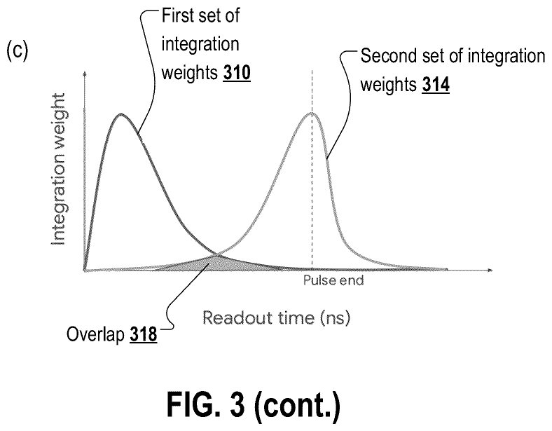

If the overlap between the integrations is less than p², fewer correlated failures will be caused compared to the natural error mechanisms that are already produced, and so performance will not be substantially degraded. Example integration windows and integration weights are shown and described below with reference to FIG. 3.

The first set of integration weights and first integration window 220 and second set of integration weights and a second integration window 224 can be determined in advance, e.g., using an optimization process. For example, the system 200 (or an external third party system) can determine the first set of integration weights and first integration window 220 and second set of integration weights and a second integration window 224 in advance, e.g., during a calibration process, and store the determined sets of integration weights and integration windows in a database or lookup table. Then, when the readout operation 208 is executed by the quantum computing device 202 and the digitalized representation of the readout signal 212 is provided to the classical signal processor 204, the classical signal processor 204 can retrieve the first set of integration weights and first integration window 220 and second set of integration weights and a second integration window 224 from the database or lookup table to perform the corresponding integrations.

The optimization process is configured to adjust the integration windows and integration weights to maximize the fidelity of the measurement value 214 and the preparation value 216 based on device parameters, e.g., the energy decay rate of the resonator used to perform the readout operation 208 and/or the decay time of the qubit coupled to the resonator, properties of the readout signal, e.g., the signal-to-noise ratio or information flow density, and, in some implementations, the duration of the readout operation 208. The optimization process can be a constrained optimization process, e.g., the optimization can include a constraint that ensures that the overlap between the integrations defined by the first set of integration weights and first integration window 220 and second set of integration weights and a second integration window 224 is bounded such that the predicted correlated error between the outputs of the integrations is less than p². The optimization process can include standard optimization techniques including, e.g., matched filtering, maximum likelihood estimation, least squares fitting, empirical calibration, or machine learning techniques.

The classical signal processor 204 is configured to output the results of the integrations 218, 222 as the measurement value 214 and preparation value 216, respectively. These values can be used as results of the quantum computation being performed by the quantum computing device 202.

Typically, quantum computations performed by the quantum computing device 202 will be noisy due to the unavoidable presence of errors caused by, e.g., unwanted interactions between qubits, unwanted interactions with the environment (causing decoherence), faulty quantum gates or operations, or errors in the state preparation or measurement process. Therefore, in some implementations the quantum computing device 202 can be configured to execute a quantum error correcting code when performing quantum computations.

FIG. 2B depicts the example system 200 of FIG. 2A during execution of a quantum error correction code 210. During execution of the quantum error correcting code 210, the quantum computing device 202 is configured to perform syndrome measurements on measure qubits to monitor and correct errors that may occur, e.g., due to noise. Results of the syndrome measurements (generated by the classical signal processor 204) are provided to a decoder 206.

The decoder 206 is a processor that can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, one or more qubits, or a combination of one or more of them. The decoder 206 is configured to process the results of the syndrome measurements to decode the results, i.e., predict which errors may have occurred during the quantum computation performed by the quantum computing device 202. To process the results, the decoder 206 uses a measurement-to-detector translation layer to map the results of the syndrome measurements to so-called detectors.

In standard quantum error correction circuits where readout involves performing a measurement operation followed by a reset operation, the results of the syndrome measurement only includes a measurement value corresponding to the measurement operation. This is because the reset operations put measure qubits in a known state (+Z eigenstate), so the decoder 206 can assume that the preparation value is zero. Therefore, to compute a detector, the decoder 206 only needs to add the measurement values for the detector (since adding the preparation values which are all zero, does not affect the summation). In cases where the quantum error correction circuit uses the presently described double-ended-measurement, the results of the syndrome measurement includes a measurement value 214 and a preparation value 216. Therefore, to compute a detector, the decoder 206 add the measurement values for the detector and the preparation values for the detector.

The decoder 206 uses the detectors to generate a detector graph 226 on which a decoding algorithm 228 is performed. Since the presently described double-ended-measurement only affects how the detectors are computed, no changes to the underlying quantum error correction code or decoding algorithm are required. After the decoder 206 has completed the decoding algorithm 228, the decoder 206 can generate a correction operator which can be applied to the quantum error correcting code 210 to correct the errors identified by the decoder 206.

FIG. 3 shows three plots (a), (b), (c) of example sets of integration weights for processing a digital representation of a readout signal. In each plot the x-axis represents readout time in nanoseconds (i.e., the duration of the readout operation) and the y-axis represents integration weight.

In plot (a), the first integration window 300 and the second integration window 302 are disjoint (and therefore the first set of integration weights 304 and the second set of integration weights 306 are disjoint). For example, the first integration window 300 corresponds to a first time range over which a digitalized representation of a readout signal is integrated, e.g., starting at a time t=0 that corresponds to when the microwave drive pulse is turned on and applied to the readout resonator and ending before the microwave drive pulse is turned off (at a time corresponding to the pulse end 308). The first set of integration weights 304 in the first integration window 300 therefore follows an upwards exponential curve that tracks the information flow density of the readout signal as the readout resonator rings up in response to the microwave pulse drive.

The second integration window 302 corresponds to a second time range over which the digitalized representation of the readout signal is integrated, e.g., starting when the first time range ends (before the microwave drive pulse is turned off) and ending after the microwave drive pulse is turned off and the resonator has rung down due to energy dissipation. The second set of integration weights 306 in the second integration window 302 therefore includes a downwards exponential curve that tracks the reduction in information flow density of the readout signal as the readout resonator rings down in response to the microwave pulse drive being turned off.

The fidelity of the measurement value (and preparation value) depends on the area under the curves defined by the first integration window 300 and the first set of integration weights 304 (and the second integration window 302 and the second set of integration weights 306). Therefore, to ensure that a target fidelity for each value is achieved, in some implementations the duration of the readout operation can be extended to increase the area under the curves, e.g., compared to a standard readout operation where only one value—the measurement value—is obtained from the readout signal. The duration of the readout operation and the target fidelities can be included as adjustable parameters in the optimization process used to determine the integration windows and integration weights.

In plot (b), the first integration window and the second integration window can overlap. For example, the first integration window and the second integration window can be a same integration window 312. In these implementations, the integration curves defined by the first set of integration weights 310 and the second set of integration weights 314 can overlap. For example, starting at a time at which the microwave drive pulse is turned on and applied to the readout resonator, the first set of integration weights 310 follow a steep upwards exponential curve that tracks the information flow density of the readout signal as the readout resonator rings up, immediately followed by a downwards exponential curve, which tails off close to (e.g., within some predetermined distance from) a time at which the microwave drive pulse is turned off (pulse end 316). Then, starting at the time at which the microwave drive pulse is turned on and applied to the readout resonator, the second set of integration weights 314 follow a slow upwards exponential curve, which reaches a maximum at a time close to (e.g., within some predetermined distance from) the time at which the microwave drive pulse is turned off. The second set of integration weights 314 can then follow a steep downwards exponential curve, which tails off at the end of the integration window. In this example, the exponential curves in the second set of integration weights 314 are a time reverse of the exponential curves in the first set of integration weights 310.

In the example shown in plot (b), the curves defined by the first set of integration weights 310 and the second set of integration weights 314 cross at a time before the time at which the microwave drive pulse is turned off (pulse end 316), and the areas under the curves overlap. The overlap is shaded in plot (c). As discussed above, by bounding the size of the overlap 318, the predicted likelihood of a correlated error between the measurement value and the preparation value is suppressed.

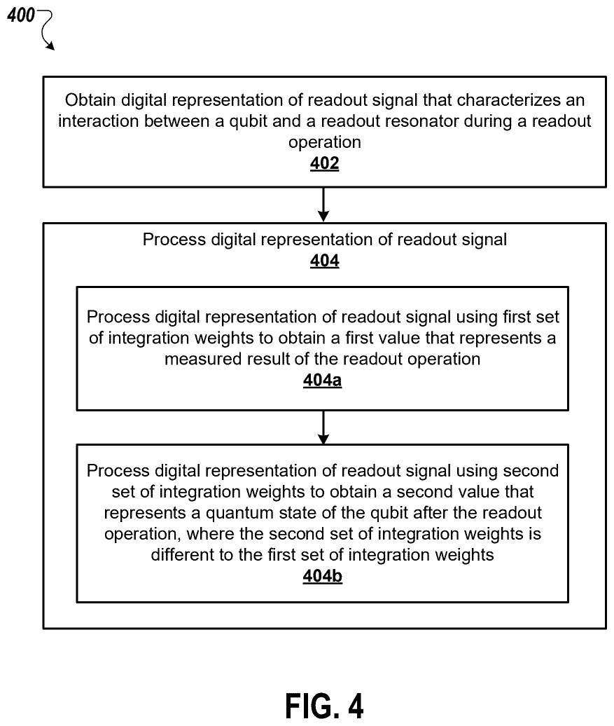

FIG. 4 is a flow diagram of an example process 400 for double-ended measurement of a qubit in a quantum computing device. For convenience, the process 400 will be described as being performed by a classical computing system. For example, the signal processing system 204 of FIG. 2, appropriately programmed in accordance with this specification, can perform the process 400.

The system obtains a digital representation of a readout signal that characterizes an interaction between a qubit and a readout resonator during a readout operation (step 402). For example, the quantum computing device can perform the readout operation on the qubit and readout resonator, e.g., through application of a drive pulse to the readout resonator. The resulting readout signal can then be fed to an analog-to-digital converter to generate the digital representation of the readout signal. The system can then obtain the digital representation of the readout signal from the quantum computing device. The readout operation can be a standard readout operation implemented by the quantum computing device to measure the quantum state of the qubit.

The system processes the digital representation of the readout signal using signal processing techniques (step 404). In particular, the system processes the digital representation of the readout signal using a first set of integration weights to obtain a first value that represents a measured result of the readout operation (step 404a). For example, the system integrates the digital representation of the readout signal using the first set of integration weights over a first integration window.

The system also processes the digital representation of the readout signal using a second set of integration weights to obtain a second value that represents a quantum state of the qubit after the readout operation, where the second set of integration weights is different to the first set of integration weights (step 404b). For example, the system integrates the digital representation of the readout signal using the second set of integration weights over a second integration window.

In some implementations the first integration window and the second integration window are disjoint, e.g., as shown in plot (a) of FIG. 3. In these implementations, the readout operation is equivalent to a measurement operation on the qubit followed by a state preparation operation on the qubit. The first integration window precedes the second integration window, e.g., as shown in plot (a) of FIG. 3. The first set of integration weights and second set of integration weights can be predetermined based on an information flow density, e.g., signal-to-noise ratio, of the readout signal (or the digital representation of the readout signal). For example, the first set of integration weights and second set of integration weights can be determined in advance using an optimization process that adapts integration weights to parts of the readout signal that carry the most useful information in order to optimize the fidelity of the first value and the second value. In some implementations the first set of integration weights and second set of integration weights can be determined based on an energy decay rate of the readout resonator and target fidelities of the first value and the second value.

In other implementations, the first integration window and the second integration window overlap, e.g., as shown in plot (b) of FIG. 3. In these implementations, the readout operation can be a so-called long readout operation, e.g., a readout operation with a readout duration of one or more microseconds. The first set of integration weights and second set of integration weights can be predetermined based on an information flow density of the readout signal, a decay rate of the readout resonator, a decay rate of the qubit, and target fidelities of the first value and the second value, e.g., using an optimization process as described above. In some implementations the first set of integration weights can follow a decay rate of the readout resonator in a first period of the first integration window and follow a decay rate of the qubit in a second period of the first integration window, where the first period precedes the second period, as shown and described with reference to plot (b) of FIG. 3. In these implementations, the second set of integration weights can be a time reverse of the first set of integration weights (with respect to the readout time/duration of the readout operation).

In implementations where the first integration window and the second integration window overlap, the first set of integration weights and second set of integration weights can be determined such that the amount of overlap is less than a predetermined threshold. The predetermined threshold depends on a predicted likelihood that a correlated error between the first value and the second value occurs during the readout operation. In particular, the predicted likelihood that the correlated error occurs is equal to p², where p represents a predicted likelihood that the first value is erroneous and represents a likelihood that the second value is erroneous. In these implementations, the readout operation is equivalent to a measurement operation on the qubit followed by a state preparation operation on the qubit.

Example process 400 can be applied to any quantum computation that requires a qubit to be measured and prepared in a known quantum state, whilst ensuring the independence of the failure of either of these two operations. For example, example process 400 can be performed to improve the time-like distance in topological quantum error correction codes. In these examples, the qubit is a measure qubit, and the readout operation is performed as part of a syndrome measurement in a quantum error correction cycle that is performed during a quantum computation. The output first value and second value can then be provided to a quantum error correction decoder, e.g., together with other first values and second values obtained through double-ended measurement of other measure qubits in the underlying logical qubit, to detect errors in the quantum computation. The decoder (or a preceding measurement-to-detector layer) can use the first values and second values to generate a decoder graph on which a decoding algorithm is executed on to detect the errors in the quantum computation. Once the errors have been detected, appropriate correction operations can be determined and applied to the quantum computing device. As another example, example process 400 can be used to prepare a qubit in a random state, e.g., as part of an implementation of randomized compiling. Randomized compiling is a technique where qubit values are purposely randomized so that the effects of asymmetric noise channels are averaged out.

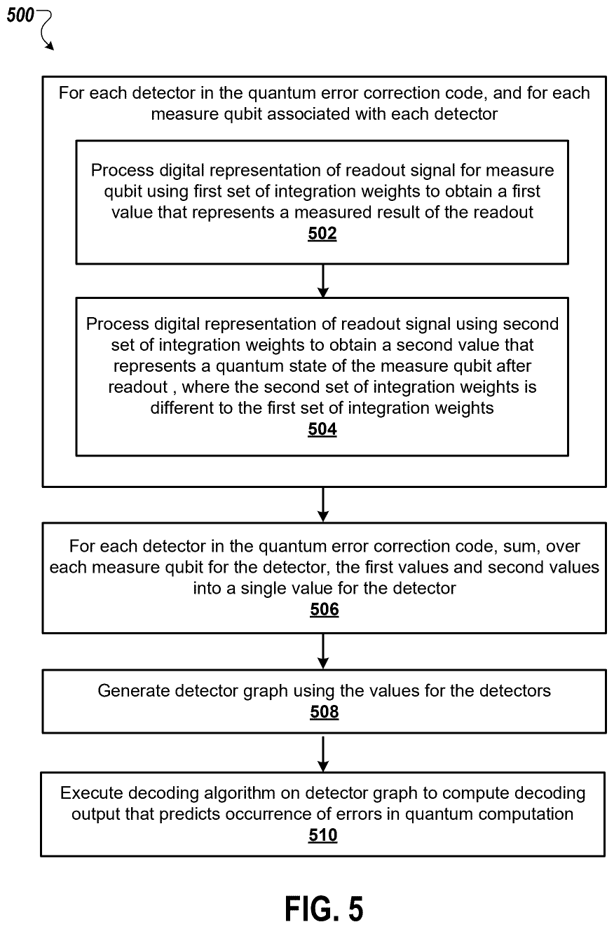

FIG. 5 is a flow diagram of an example process 500 for double-ended measurement of a qubit in a quantum computing device that implements a quantum error correction code, e.g., a topological code such as the surface code. For convenience, the process 500 will be described as being performed by a quantum computing system. For example, example system 200 of FIG. 2B, appropriately programmed in accordance with this specification, can perform the process 500. Example process 500 can be combined with the techniques described above with reference to FIGS. 1, 2A-B, 3, and 4.

During execution of a quantum computation that uses the quantum error correction code, and for each detector in the quantum error correction code (where each detector is associated with a respective type of error, e.g., bit-flip error, phase-flip error, or depolarizing error, and is designed to extract syndromes related to the respective type of error), the system performs the following operations. For each measure qubit associated with the detector, the system processes a digital representation of a readout signal for the measure qubit for the detector using a first set of integration weights to obtain a first value that represents a measured result of the readout operation (step 502). The system also processes the digital representation of the readout signal using a second set of integration weights to obtain a second value that represents a quantum state of the measure qubit for the detector after readout, where the second set of integration weights is different to the first set of integration weights (step 504). The system then sums the first values and second values (over each measure qubit associated with the detector) to obtain a single value for the detector (step 506). The system generates a detector graph using the values for each detector in the quantum error correction code (step 508) and executes a decoding algorithm on the detector graph to compute a decoding output that predicts an occurrence of errors in the quantum computation (step 510). The decoding algorithm can be any decoding algorithm designed to operate on a detector graph, e.g., a union find algorithm, minimum weight perfect matching, or variations thereof.

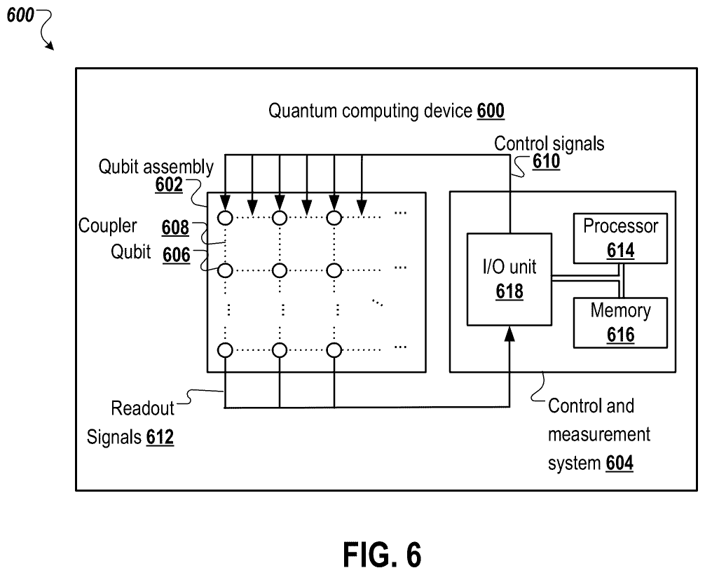

FIG. 6 depicts an example quantum computing device 600 for performing the operations described in this specification. The quantum computing device 600 is intended to represent various forms of quantum computing devices. The components shown here, their connections and relationships, and their functions, are exemplary only, and do not limit implementations of the inventions described and/or claimed in this document.

The example quantum computing device 600 includes a qubit assembly 602 and a control and measurement system 604. The qubit assembly includes multiple physical qubits, e.g., qubit 606, that are used to perform algorithmic operations or quantum computations. While the qubits shown in FIG. 6 are arranged in a rectangular array, this is a schematic depiction and is not intended to be limiting. The qubit assembly 602 also includes adjustable coupling elements, e.g., coupler 608, that allow for interactions between coupled qubits. In the schematic depiction of FIG. 6, each qubit is adjustably coupled to each of its four adjacent qubits by means of respective coupling elements. However, this is an example arrangement of qubits and couplers, and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 600 or the type of quantum computations that the quantum computing device 600 is performing. For example, in a superconducting quantum computer the qubits may be realized via superconducting qubits, e.g., superconducting transmon qubits. As another example, in a NMR quantum computer the qubits may be realized via nuclear spin states. As another example, in a neutral atom quantum computer the qubits may be realized via an array of neural atoms, e.g., rubidium or cesium, where Rydberg interactions allow for implementations of multi-qubit gates and facilitate connectivity between qubits in the array.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), iSWAP gates, and gates involving three or more qubits, e.g., Toffoli gates. The quantum logic gates can be implemented by applying control signals 610 generated by the control and measurement system 604 to the qubits and to the couplers, where the control signals implement corresponding control pulse/gate sequences.

For example, in some implementations the qubits in the qubit assembly 602 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 610 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 610. The measurements cause readout signals 612 representing measurement results to be communicated back to the measurement and control system 604. The readout signals 612 may include RF, microwave, or optical signals depending on the physical scheme for the quantum computing device and/or the qubits. For convenience, the control signals 610 and readout signals 612 shown in FIG. 6 are depicted as addressing only selected elements of the qubit assembly (i.e. the top and bottom rows), but during operation the control signals 610 and readout signals 612 can address each element in the qubit assembly 602.

The control and measurement system 604 is an example of a classical computer system that can be used to perform various operations on the qubit assembly 602, as described above, as well as other classical subroutines or computations described herein. The control and measurement system 604 includes one or more classical processors, e.g., classical processor 614, one or more memories, e.g., memory 616, and one or more I/O units, e.g., I/O unit 618, connected by one or more data buses. The control and measurement system 604 can be programmed to send sequences of control signals 610 to the qubit assembly, e.g. to carry out a selected series of quantum gate operations, and to receive sequences of readout signals 612 from the qubit assembly, e.g. as part of performing measurement operations.

The processor 614 is configured to process instructions for execution within the control and measurement system 604. In some implementations, the processor 614 is a single-threaded processor. In other implementations, the processor 614 is a multi-threaded processor. The processor 614 is capable of processing instructions stored in the memory 616.

The memory 616 stores information within the control and measurement system 604, e.g., data specifying pre-distorted control pulses. In some implementations, the memory 616 includes a computer-readable medium, a volatile memory unit, and/or a non-volatile memory unit. In some cases, the memory 616 can include storage devices capable of providing mass storage for the system 604, e.g. a hard disk device, an optical disk device, a storage device that is shared over a network by multiple computing devices (e.g., a cloud storage device), and/or some other large capacity storage device.

The input/output device 618 provides input/output operations for the control and measurement system 604. The input/output device 618 can include D/A converters, A/D converters, and RF/microwave/optical signal generators, transmitters, and receivers, whereby to send control signals 610 to and receive readout signals 612 from the qubit assembly, as appropriate for the physical scheme for the quantum computer. In some implementations, the input/output device 618 can also include one or more network interface devices, e.g., an Ethernet card, a serial communication device, e.g., an RS-232 port, and/or a wireless interface device, e.g., an 802.11 card. In some implementations, the input/output device 618 can include driver devices configured to receive input data and send output data to other external devices, e.g., keyboard, printer, and display devices.

Although an example control and measurement system 604 has been depicted in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions, or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g., qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer implemented method comprising:
obtaining a digital representation of a readout signal that characterizes an interaction between a qubit and a readout resonator during a readout operation; and
processing the digital representation of the readout signal, comprising:
processing the digital representation of the readout signal using a first set of integration weights to obtain a first value that represents a measured result of the readout operation; and
processing the digital representation of the readout signal using a second set of integration weights to obtain a second value that represents a quantum state of the qubit after the readout operation, wherein the second set of integration weights is different to the first set of integration weights.

2. The method of claim 1, wherein:
processing the digital representation of the readout signal using the first set of integration weights comprises integrating the digital representation of the readout signal using the first set of integration weights over a first integration window; and
processing the digital representation of the readout signal using the second set of integration weights comprises integrating the digital representation of the readout signal using the second set of integration weights over a second integration window, wherein the first integration window and the second integration window are disjoint.

3. The method of claim 2, wherein the first integration window precedes the second integration window.

4. The method of claim 2, wherein the readout operation is equivalent to a measurement operation on the qubit followed by a state preparation operation on the qubit.

5. The method of claim 2, wherein the first set of integration weights and second set of integration weights are predetermined based on an energy decay rate of the readout resonator and target fidelities of the first value and the second value.

6. The method of claim 2, wherein the first set of integration weights and second set of integration weights are predetermined based on an information flow density of the readout signal.

7. The method of claim 1, wherein:
processing the digital representation of the readout signal using the first set of integration weights comprises integrating the digital representation of the readout signal using the first set of integration weights over a first integration window; and
processing the digital representation of the readout signal using the second set of integration weights comprises integrating the digital representation of the readout signal using the second set of integration weights over a second integration window, wherein the first integration window and the second integration window overlap.

8. The method of claim 7, wherein the readout operation comprises a long readout operation with a readout duration of one or more microseconds.

9. The method of claim 7, wherein the first set of integration weights and second set of integration weights are predetermined based on an information flow density of the readout signal, a decay rate of the readout resonator, a decay rate of the qubit, and target fidelities of the first value and the second value.

10. The method of claim 7, wherein the first set of integration weights follow a decay rate of the readout resonator in a first period of the first integration window and follow a decay rate of the qubit in a second period of the first integration window, wherein the first period precedes the second period.

11. The method of claim 10, wherein the second set of integration weights comprise a time reverse of the first set of integration weights.

12. The method of claim 7, wherein the overlap is less than a predetermined threshold, wherein the predetermined threshold depends on a predicted likelihood that a correlated error between the first value and the second value occurs during the readout operation.

13. The method of claim 12, wherein the predicted likelihood that the correlated error occurs is equal to p², wherein p represents a predicted likelihood that the first value is erroneous and represents a likelihood that the second value is erroneous.

14. The method of claim 13, wherein the readout operation is equivalent to a measurement operation on the qubit followed by a state preparation operation on the qubit.

15. The method of claim 1, wherein the qubit comprises a measure qubit and the readout operation is performed as part of a syndrome measurement in a quantum error correction cycle that is performed during a quantum computation.

16. The method of claim 15, further comprising providing the first value and the second value to a quantum error correction decoder to detect errors in the quantum computation.

17. The method of claim 16, wherein the quantum error correction decoder generates a decoder graph using the first value and the second value, wherein a decoding algorithm is performed on the decoder graph to detect the errors in the quantum computation.

18. The method of claim 1, further comprising performing, by quantum computing hardware, the readout operation on the qubit and the readout resonator.

19. The method of claim 1, wherein the qubit is a superconducting qubit, the readout resonator is a microwave cavity, and the readout signal is a microwave signal.

20. A classical signal processing system comprising one or more computers and one or more storage devices storing instructions that are operable, when executed by the one or more computers, to cause the one or more computers to perform operations comprising:
obtaining a digital representation of a readout signal that characterizes an interaction between a qubit and a readout resonator during a readout operation; and
processing the digital representation of the readout signal, comprising:
processing the digital representation of the readout signal using a first set of integration weights to obtain a first value that represents a measured result of the readout operation; and
processing the digital representation of the readout signal using a second set of integration weights to obtain a second value that represents a quantum state of the qubit after the readout operation, wherein the second set of integration weights is different to the first set of integration weights.
